(19) United States
(12) Patent Application Publication
(10) Pub. No.: US 2007/0193835 A1
(43) Pub. Date: Aug. 23, 2007

(54) Actuator and brake assembly

(75) Inventor: Nui Wang, Victoria (AU)

Correspondence Address: FISH & RICHARDSON PC, P.O. BOX 1022, MINNEAPOLIS, MN, 55440-1022, US

(73) Assignee: PBR AUSTRALIA PTY LTD, East Bentleigh (AU)

(21) Appl. No.: 10/566,283

(22) PCT Filed: Jul. 28, 2004
(86) PCT No.: PCT/AU04/01007

§ 371 Date: Jun. 26, 2006

(30) Foreign Application Priority Data
Jul. 28, 2003 (AU) 2003903927

(51) Int. Cl. B60T 1/06

(52) U.S. Cl. 188/17

(57) ABSTRACT

An actuator, including an electric motor (14) having a stator (16) and a rotor (17), in which the rotor (17) defines a bearing surface (20) having a non-circular profile, and a radially flexible annular sleeve (24) defines a facing bearing surface. The flexible sleeve (24) adopts a non-circular shape complementary to the profile of the bearing surface (20). The flexible sleeve (24) is restrained against rotation and is in toothed meshing engagement with a circular drive ring (26) at least two contact regions which are equidistantly spaced apart. The drive ring (26) is rotationally engaged with a screw and threaded sleeve assembly, such that rotation of the drive ring (26) drives the screw and sleeve assembly and causes extension or withdrawal of an output portion (28) of the screw and sleeve assembly for actuation. The actuator is operable such that rotation of the rotor (17) causes the flexible sleeve (24) to flex radially at each of the contact regions to generate a rolling wave which causes rotation of the contact regions and of the drive ring (26), and the drive ring (26) rotates at a reduced rotational velocity as compared to the rotational velocity of the rotor (17).

The present invention relates to an actuator, principally, but not exclusively for employment in a brake assembly and therefore the invention also relates to a brake assembly that employs such an actuator. It will be convenient to describe the invention as an actuator for a brake assembly, but it should be appreciated that the invention could be employed for other actuation applications.

The actuator of the present invention is electrically operated, in keeping with recent trends to develop commercially acceptable electric brakes of both the service and/or parking kind. However, much of the development to date has resulted in actuating arrangements and therefore brake assemblies which are bulky and/or lengthy and which are therefore difficult to accommodate in the vehicle space historically made available for non-electric, hydraulically operated brakes. One such electric brake includes an electric motor arranged in series with a brake pad drive arrangement and the series configuration causes the overall assembly to have excessive length. Constructing the electric brake in a parallel manner, in which the electric motor overlies or underlies the drive arrangement, effectively reduces the length of the brake, but increases its lateral bulk to an unacceptable level.

It is an object of the present invention to overcome or at least alleviate drawbacks associated with the prior art. It is a further object of the invention to provide an electric brake assembly which is effective for service brake operation and which has a compact form which approximates the space taken up by existing hydraulic operated brake assemblies.

The present invention provides an actuator, including an electric motor having a stator and a rotor, in which said rotor defines a bearing surface having a non-circular profile, and a radially flexible annular sleeve defines a facing bearing surface the arrangement between the facing bearing surfaces being such that said flexible sleeve adopts a non-circular shape complementary to said profile of said bearing surface of said rotor, said flexible sleeve is restrained against rotation and is in toothed meshing engagement with a circular drive ring at least two contact regions which are equidistantly spaced apart, said drive ring is rotationally engaged with a screw and threaded sleeve assembly, such that rotation of said drive ring drives said screw and sleeve assembly and causes extension or withdrawal of an output portion of said screw and sleeve assembly for actuation, said actuator being operable such that rotation of said rotor causes said flexible sleeve to flex radially at each of said contact regions to generate a rolling wave which causes rotation of said contact regions and of said drive ring, and whereby said drive ring rotates at a reduced rotational velocity as compared to the rotational velocity of said rotor.

The above arrangement advantageously permits a construction which is compact in overall bulk and length. In particular, the rotational nature of the arrangement permits the components to be arranged about each other, or coaxially rather than connected end to end.

The screw and sleeve assembly preferably is a ball screw assembly, so that the actuator is operational with high efficiency. However, less efficiency may be preferred in some circumstances, for example where backdriving is to be resisted in the screw and sleeve assembly.

It is preferred that each of the bearing surfaces of the rotor and the flexible sleeve, each define a ball bearing race and that balls are disposed between and in rolling contact with the respective races. Alternatively, a lubricated journal bearing or bush could be employed, or instead of balls, needle or roller bearings could be employed.

In the preferred arrangement, the bearing surface of the rotor has an elliptical profile such that the flexible sleeve adopts an elliptical shape complementary to the elliptical rotor profile. In this arrangement, the flexible sleeve is in toothed meshing engagement with the drive ring at two contact regions which are diametrically opposed, such that the rolling wave which is generated upon rotation of the rotor, is an elliptical rolling wave. In the alternative, the rotor could define a non-circular and non-elliptical profile, for example a tri-lobal profile which results in engagement with the drive ring with three equidistantly spaced contact regions. Indeed, any number of contact regions may be generated, for example four or five contact regions may be appropriate depending of the construction of the actuator. If the actuator is to be employed for brake actuation, it is likely that a maximum of three contact regions would be required, but most likely, the arrangement discussed above, in which the rotor defines an elliptical profile which generates two contact regions, would be employed.

The electric motor can take any suitable form, but in one preferred form, the rotor is disposed co-axially within the stator and the rotor includes a magnet backing ring which accommodates a magnetic arrangement on the radially outer surface thereof, such as a plurality of magnets mounted to the radially outer surface, and an inner elliptical profile as discussed above. Preferably that profile includes a ball track, to partially capture balls disposed between the magnet backing ring and the flexible sleeve, while a similar ball track is preferably provided on the ball bearing race surface of the flexible sleeve. In one preferred arrangement, a flexible collar is mounted about the flexible sleeve and the collar defines the facing bearing surface or ball race of the flexible sleeve.

The meshing engagement between the flexible sleeve and the drive ring preferably occurs by way of teeth or splines which are provided on the facing surfaces of those parts. In relation to the flexible sleeve, it is appropriate for the teeth or spline formation to be formed directly on the flexible sleeve. Alternatively, the tooth or splined arrangement can be formed a separate band which is fixed to the flexible sleeve in any suitable manner.

The toothed or splined arrangement of the drive ring, preferably is formed directly on the surface thereof although again, a separate toothed band may be attached to the circular ring.

The drive ring is preferably rotationally connected to an input member which forms the input of the ball screw assembly. The drive ring therefore forms the output of the meshing geared arrangement described above and as an output, is operable to drive the input of the ball screw assembly. Preferably the input member of the ball screw assembly is a sleeve member, which is disposed co-axially with the drive ring, and with the screw portion of the ball screw assembly. The fixed connection of the drive ring with the input sleeve is such as to cause the input sleeve to rotate upon rotation of the drive ring. Preferably the input sleeve is restrained against axial movement, while the screw portion of the ball screw assembly is restrained against rotational movement, so that rotation of the input sleeve results in axial displacement of the screw portion. By that axial displacement, the screw portion can engage, for example, against the rear of a brake pad, for displacing the brake pad into engagement with a rotor of a disc brake caliper. In order to evenly distribute the brake application load, the screw portion may engage against a load spreader, which distributes the load more evenly across the rear surface of a disc brake pad.

In a preferred arrangement of the present invention, the actuator is operable to actuate a brake assembly, such as a drum brake assembly or a disc brake assembly. The actuator may be mounted within a disc caliper housing, with the stator of the electric motor being radially the outermost component of the overall assembly within the housing, preferably within a rear portion of the housing. In this arrangement, the rotor is mounted co-axially and radially inwardly of the stator, and likewise each of the flexible sleeve, the drive ring, the ball screw input sleeve and the screw portion, are each co-axially mounted about each other. By that form of co-axial mounting, an extremely compact actuating arrangement is provided.

Accordingly, the present invention further provides a disc brake caliper including a housing arranged to straddle a rotor disc and an anchor bracket for attaching the caliper to a vehicle, the housing supporting a pair of brake pads on opposite sides of the disc and displacement of a first of the brake pads into engagement with one side of the disc causes said housing to shift relative to said anchor bracket to bring the second of said brake pads into engagement with a second and opposite side of the disc, said housing at least partly accommodating an actuator for displacing said first brake pad into engagement with said disc, said actuator including an electric motor having a stator and a rotor, in which said rotor defines a bearing surface having a non-circular profile, and a radially flexible annular sleeve defines a facing bearing surface the arrangement between the facing bearing surfaces being such that said flexible sleeve adopts a non-circular shape complementary to said profile of said bearing surface of said rotor, said flexible sleeve is restrained against rotation and is in toothed meshing engagement with a circular drive ring at least two contact regions which are equidistantly spaced apart, said drive ring is rotationally engaged with a screw and threaded sleeve assembly, such that rotation of said drive ring drives said screw and sleeve assembly and causes extension or withdrawal of an output portion of the said ball screw assembly for displacement of said first brake pads, said actuator being operable such that rotation of said rotor causes said flexible sleeve to flex radially at each of said contact regions to generate a rolling wave which causes rotation of said contact regions and of said drive ring, and whereby said drive ring rotates at a reduced rotational velocity as compared to the rotational velocity of said rotor.

Various modifications can be made to the above discussed arrangement in keeping with the present invention. In particular, while the above discussion indicates that the flexible sleeve is torsionally fixed, in an alternative arrangement that sleeve can be arranged to rotate, with the drive ring fixed torsionally. In that arrangement, the input sleeve of the ball screw assembly is driven by the flexible sleeve rather than by the drive ring.

The attached drawings show an example embodiment of the invention of the foregoing kind. The particularity of those drawings and the associated description does not supersede the generality of the preceding broad description of the invention.

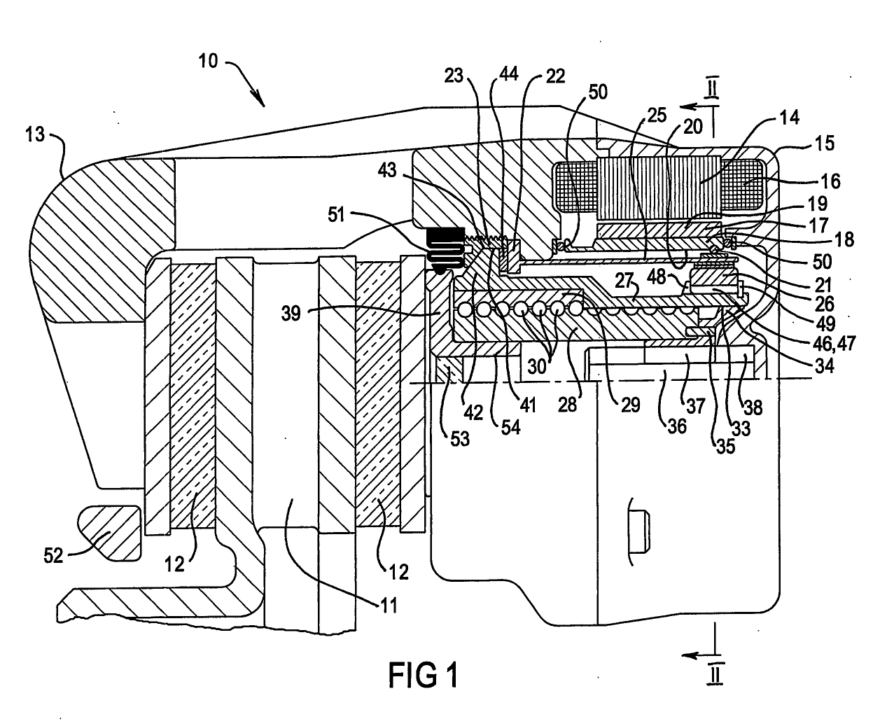

FIG. 1 is a cross-sectional view of a disc brake caliper according to one embodiment of the invention.

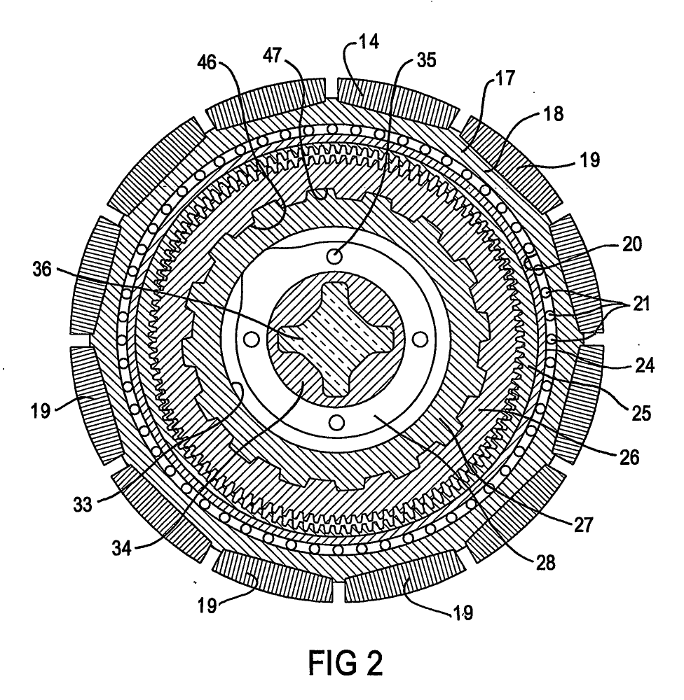

FIG. 2 is a cross-sectional of the disc brake caliper of FIG. 1, taken through II-II of FIG. 1.

Referring to FIGS. 1 and 2, a disc brake caliper 10 is shown, which includes a rotor 11 and a pair of brake pads 12 disposed on either side of the rotor 11. The pads 12 are shown in a rotor engaged condition and a person skilled in the art will appreciate the operation of the caliper for pad movement into and away from the condition shown. The caliper 10 further includes a housing 13, the construction and operation of which will also be apparent to a person skilled in the art.

The present invention resides in the actuator of the disc brake caliper 10 and the construction of the caliper to accommodate that mechanism and its operation. The actuator as shown, advantageously is housed in the position which typically houses the piston drive of prior art calipers and includes an electric motor 14 disposed within a cover section 15 of the housing 13, and which comprises a stator 16, positioned radially outermost of the cover section 15, and a rotor 17. As shown in FIG. 2, the rotor 17 comprises a magnet backing ring 18 to which is mounted a plurality of magnet segments 19 spaced equidistantly about the backing ring 18. As will be readily understood, supply of an electric current to the stator 16 in the normal manner will apply a force to the rotor 17 tending to rotate it. Advantageously, the cover section 15 is removably attached to the housing 13, and it permits some of the parts of the caliper 10 to be assembled and removed through the rear of the caliper. The cover section 15 is fixed to the housing 13 by a plurality of screws.

The backing ring 18 is generally circular and of generally uniform cross-section throughout its circular extent, but is formed with an inner surface 20 which is elliptical rather than circular, although the deviation to elliptical from circular is not great. As discussed above, an elliptical profile is only one of the possible profiles that could be adopted. What is required is that the profile be non circular and an elliptical profile meets that requirement. The elliptical inner surface 20 forms a race for ball bearings 21, which are spaced circumferentially about the inner surface 20. The inner surface 20 defines an annular race for the balls 21 and as shown in FIG. 1, the surface 20 is formed with a concave track to accommodate and locate the balls 21. The ball bearings 21 could alternatively be captured in a bearing cage (not shown) in a known manner.

The race for the balls 21 is completed opposite the inner surface 20 by a flexible collar 24, which is formed as an annular ring, but which can flex as the balls 21 travel about the elliptical surface 20. The arrangement is such that the path of the balls 21 about the elliptical surface 20 causes the collar 24 to flex inwardly and outwardly in a wave-like manner as the rotor 17 rotates. The collar 24 is mounted about a flexible sleeve 25 which is not mounted for rotation, but rather is held stationary relative to the rotor 17. The collar 24 and the flexible sleeve 25 are fixed together to prevent relative rotation, by any suitable arrangement. In an alternative arrangement, the collar 24 can be omitted and the race which is formed on the collar, is formed directly on the radially outer surface of the flexible sleeve 25. As shown in FIG. 1 the sleeve 25 is held stationary by clamping or anchoring a rigid head 22 of the sleeve 25 against the housing 13 by a nut 23. It is clear from FIG. 1, that the major portion of the sleeve 25 is of relatively thin, flexible sheet material and also that the portion of the sleeve 25 which supports the collar 24 forming the race for the balls 21, is remote from the rigid head 22. Accordingly, the influence that the rigidity of the head 22 has on the flexibility of the sleeve 25 and the collar 24 at the end remote to the head 22, does not affect the ability of the sleeve 25 and the collar 24 to flex according to the elliptical path of the balls 21. However, the torsional restraint of the head 22 clamped against the housing 13 by the nut 23, maintains the sleeve 25 against rotation. Other arrangements to fix the head 22 relative to the housing 13 may be employed, such as employing a meshing spline arrangement, or keying pins, for example.

The above bearing arrangement could alternatively be provided by a separate flexible bearing assembly that is fitted to an elliptical profile, such as formed on the backing ring 18.

The flexible sleeve 25 defines a toothed, radially inner surface opposite the radially outer surface thereof about which the collar 24 is mounted or includes a toothed ring or band connected against the radially inner surface. The toothed surface meshes with the facing teeth formed on a circular drive ring 26. As is apparent from FIG. 2, meshing engagement between the flexible sleeve 25 and the drive ring 26 only occurs at two diametrically opposite regions, and this occurs because the flexible sleeve 25 forms an elliptical ring, due to the elliptical profile of the inner surface 20 of the backing ring 18, whereas the drive ring 26 is rigid and is formed with an outer circular profile. Where meshing engagement is required at more than two regions, three or more contact regions can be provided by suitable selection of the inner surface 20 of the backing ring 18. As will become apparent later, the meshing regions described above rotate as the rotor 17 rotates, but they remain at all times diametrically opposed. The arrangement is such that rotation of the meshing regions without rotation of the sleeve 25 results in rotation of the drive ring 26, although at a reduction ratio dependent on the difference in teeth numbers between the sleeve 25 and the drive ring 26 (with the sleeve 25 having as a matter of necessity, a greater number of teeth than the drive ring 26, the difference in this example, being of necessity a multiple of 2).

The drive ring 26 is connected through a splined or toothed engagement with a cylindrical ball screw input sleeve 27, so that rotation of the drive ring 26 causes rotation of the sleeve 27. The sleeve 27 extends axially over and about a ball screw 28 which defines a race axially along the radially outer surface thereof. A ball nut 29 is connected to the sleeve 27 for fixed rotation therewith and defines a further race complementary to the race formed on the ball screw 28 and the respective races cooperate to accommodate a plurality of balls 30. The ball nut 29 is fixed to a radially inner face of the input sleeve 27 in any suitable manner, such as by splined or key engagement and includes internal recirculation guides for recirculating the balls 30 as they traverse axially along the ball race. As is evident from FIG. 1, the nut 29 extends axially for approximately only half the length of the ball screw 28. For the remaining portion of the screw 28, the sleeve 27 closely overlies the peaks or crests of the screw 28 and extends beyond the axial end thereof. At that end of the sleeve 27, the sleeve defines a radially inward facing journal surface 33 which engages in sliding contact against the radially outer surface of a sleeve 34 which is fixed to the end of the ball screw 28 by a plurality of pins 35. By this arrangement, the ball screw 28 is supported in a manner to minimise cocking or skewing movement which might otherwise occur under the brake application loading.

The sleeve 34 extends to a position to underlie the underneath or radially inward facing surface of the ball screw 28 and that portion of the sleeve 34 is keyed or meshed to a shaft 36 at 37. This keying or meshing engagement is such as to permit axial sliding movement of the sleeve 34 and therefore the ball screw 28 to which the sleeve 34 is connected, but not to permit rotation of the ball screw 28 and the sleeve 34. The shaft 36 is prevented from rotating by its fixed connection at the rear end thereof to the cover section 15 at 38. That fixed connection can take any suitable form, such as a pin or bolt fixed to the cover section 15 and extending into a recess or opening formed in the rear end of the shaft 36. Other arrangements which facilitate axial movement of the sleeve 34, but which prevent its rotation, could alternatively be employed.

At the opposite end of the ball screw 28, the screw cooperates with a load spreader 39 which is in engagement with the rear side of the inboard brake pad 12. The load spreader 39 is operable to spread the axial load applied by the ball screw 28 across a greater area of the rear side of the brake pad.

In order to apply a braking load, an electrical current is applied to the stator 16 to drive the rotor 17. This drives the backing ring 18 to rotate and by the elliptical inner race 20 of the backing ring 18, the balls 21 move in an elliptical path. The collar 24 and the flexible sleeve 25 are also caused to move in a wave-like manner, radially inwardly and outwardly, but not to rotate, because as previously described, the sleeve 25 is fixed torsionally to the housing 13 by the nut 23. Thus, the sleeve 25 has flexing movement only, imparted to it by the elliptical path of the balls 21 as they are driven by the rotating backing ring 18.

The sleeve 25, at the end remote from the head 22 therefore has a wave-like movement as the rotor 17 rotates and that drives the radially inner toothed surface of the sleeve 25 in the same manner. The toothed surface therefore continuously engages and releases the teeth of the circular drive ring 26 in a rotary motion and by that movement causes the drive ring 26 to rotate, but at a reduced rotational speed compared to that of the backing ring 18. The actual reduction in rotational speed is a function of the relative number of teeth between the flexible sleeve 25 and the drive ring 26 and the number of contact regions between them. According to FIG. 2, two diametrically opposite contact regions are provided and these contact regions exist along the minor axis of the elliptical surface 20 of the backing ring 18.

For proper operation of an actuator having two contact regions, the number of teeth between the flexible sleeve 25 and the drive ring 26 must be divisible by 2, while the difference between the numbers of teeth must likewise be divisible by 2. For example, the flexible sleeve 25 could have 102 teeth and the drive ring 26 could have 100 teeth. Each of these teeth number is divisible by 2, while the difference between them, i.e., 102−100=2, is also divisible by 2. In this example, if the teeth of the sleeve and the drive ring are numbered and the first tooth of the sleeve 25 is considered to be meshed with the first tooth of the drive ring 26 at the first of the contact regions, then it can be understood that the 51^{st} tooth of the sleeve 25 meshes with the 50^{th} tooth of the drive ring 26 at the second of the contact regions. Following rotation of the rotor 17 through one complete rotation, by the elliptical wave-like drive of the sleeve 25 to the drive ring 26, the first tooth of the sleeve 25 now meshes with the third tooth of the drive ring 26 in the first but rotated contact region, while the 51^{st} tooth of the sleeve 25 will mesh with the 52^{nd} tooth of the drive ring 26 in the second contact region. Accordingly, the drive ring 26 has been rotated by 2 teeth out of 100, or in other words, by 1/50of a turn or rotation. The reduction ratio in this example is therefore 50:1.

The reduction ratio can be altered by changing the relative number of teeth of the flexible sleeve 25 and the drive ring 26 although bearing in mind the requirement for division by 2 of each of the total numbers of teeth as well as for the difference in teeth numbers between the teeth. For example, if the number of teeth is changed to 104 and 100 for the sleeve 25 and the drive ring 26 respectively, for one complete rotation of the sleeve 25, the drive ring 26 will be rotated by 4 teeth out of 100, or in other words, by 1/25of a rotation. The reduction ratio for this example therefore will be 25:1.

The reduction ratio can also be altered by the number of contact regions between the teeth of the flexible sleeve 25 and the drive ring 26. In FIG. 2, two contact regions are provided although in an alternative arrangement, three contact regions may be provided or controlled by a tri-lobal profile of the inner surface 20 of the backing ring 18, rather than the illustrated elliptical profile. In this arrangement, the relative total teeth numbers and teeth difference must each be divisible by 3 as compared to 2, if two contact regions are provided. Therefore, in an arrangement with three contact regions, a teeth ratio of 99 and 96 between the sleeve 25 and the drive ring 26 will provide a reduction ratio of 32:1. A teeth ratio of 102 and 96 will provide a reduction ratio of 16:1.

It will be appreciated that the reduction ratio can be selected as required, by provision of appropriate teeth numbers and contact regions. While the illustrated arrangement of FIG. 2, comprising two contact regions only, is considered to be the most simple arrangement, differing arrangements are clearly acceptable and within the scope of the present invention.

The preceding description facilitates an understanding of the drive reduction applicable between the rotor 17, which is the drive input, and the sleeve 27, which forms the output of the drive and the input for the ball screw 18. As discussed earlier herein, the sleeve 27 has a ball nut 29 fixedly attached thereto and rotation of the sleeve 27 results in rotation of the ball nut 29. That rotation is relative to the ball screw 28, which is fixed against rotation by suitable connection to the shaft 36, which in turn is fixed against rotation, but the connection to the shaft 36 is such as to permit relative axial sliding of the ball screw 28, for the purpose of imposing a braking load on the load spreader 39 and thus to the brake pads 12.

Accordingly the ball screw 28 is shifted axially upon rotation of the sleeve 27 by movement of the balls 30 within the races of the ball screw 28 and the ball nut 29. The sleeve 27 is restrained against forward axial movement because of the reaction loads imposed upon it through the balls 30 when it rotates to shift the ball screw 28 axially forward towards the brake pads 12. That is, a forward load on the ball screw 28 imposes a rearward load on the sleeve 27. When the sleeve 27 is not rotating and the brakes are in an off or released condition, so that the sleeve 27 is at rest, the nut 23 locates the sleeve 27 axially but without clamping against it. For this, the sleeve 27 includes a head portion 42 having an inclined surface 43 which faces a complementary surface formed by the nut 23. These surfaces are spaced to provide a very small axial clearance therebetween, although the surfaces are arranged for engagement so that the nut 23 provides axial location for the sleeve 27 when the ball screw 28 is being retracted during brake release, including retraction to set the running clearance between the brake pads 12 and the rotor 11. Moreover, the nut 23 is configured to have an annular radial facing surface to face the complementary surface of the head portion 42 (see the facing surfaces at 41) and it is possible and appropriate that the radial surface at 41 of the nut 23 form a radial bearing for the sleeve 27. The radial bearing could be a journal, or a rolling-type bearing could be employed.

The head portion 42 further defines a bearing race or a mounting surface for a needle thrust bearing 44, the opposite race or mounting surface being defined by the rigid head portion 22 formed at one end of the flexible sleeve 25. The needle thrust bearing 44 facilitates rotation of the head portion 42, and thus the entire sleeve 27 relative to the rigid head 22 and thus the torsionally fixed sleeve 25. Also, the needle thrust bearing 44 reacts the braking loads through the head 22 to the caliper housing 13. Other alternative bearings or arrangements could however be employed.

With the sleeve 27 securely located axially, it can include a suitable arrangement which cooperates with and locates the drive ring 26. As shown in FIGS. 1 and 2, the drive ring 26 and the sleeve 27 are rotationally meshed together by spline teeth 46 and 47, while FIG. 1 shows a shoulder 48 which engages one axial side of the sleeve 27 and a circlip 49 which engages the opposite axial side. By this arrangement, the drive ring 26 is axially located.

Likewise, the backing ring 18 of the rotor 17 is located radially by the balls 21 and axially by end ball bearings 50. Only a single end ball bearing might be required on either side of the rotor 17, although more may be provided as determined necessary by a person skilled in the art.

To complete the figures, the caliper arrangement further includes a convoluted boot 51 to protect the drive assembly from ingress of foreign matter, while FIG. 1 also shows a part of the torque bracket 52 which reacts the generated braking torque. FIG. 1 further shows a plug 53 for use with a load sensing device which may be applied to the load spreader 39 to monitor and/or control braking loads applied to the rotor 11. Electrical leads may be applied to the load spreader 39 and channelled through the central opening 54 thereof and sealed by the plug 53. Such leads can extend to any suitable position, such as to the cover section 15.

The arrangement illustrated in FIGS. 1 and 2 can be modified in a number of ways which still fall within the scope of the present invention. In particular while the flexible sleeve 25 has been described as being torsionally fixed and in meshed engagement with the rotatable rigid drive ring 26, in the alternative, the drive ring 26 could be fixed torsionally against rotation, with the sleeve 25 being rotatable. This would demand that the actuating mechanism be redesigned for axial movement of the ball screw 28, but if required that modification could be achieved. Still alternatively, the actuator assembly could be reversed coaxially, so that in relation to the flexible sleeve, the rotor is radially inward thereof and the drive ring is radially outward thereof.

It will be appreciated that the arrangement of FIGS. 1 and 2 is operable to provide significant reduction between input and output speeds and therefore a significant increase in output torque and because the curvature of the meshing teeth of the sleeve 25 and the drive ring 26 is very similar and because the meshing can be arranged over a large number of teeth, the load carrying capacity of the drive train is high. Moreover, because the drive arrangement is formed in an overlapping manner, or co-axial, the entire assembly is compact and axially short.

The arrangement can also employ a parking brake lock of any suitable form to lock the ball screw 28 in an advanced, brake applied condition. For example, a toothed profile could be applied to the axial end of the backing ring 18 adjacent the cover 15, for controlled engagement with a solenoid operated pin or plunger.

The arrangement furthermore can include a displacement sensor which can be incorporated into the electric motor 14. A brushless electric motor with Hall Effect sensors to provide for electric commutation and pulse generation for motor control has been provided for in the preceding description and the drawings, although other forms of electric motor and control forms could be employed.

The invention described herein is susceptible to variations, modifications and/or additions other than those specifically described and it is to be understood that the invention includes all such variations, modifications and/or additions which fall within the spirit and scope of the above description.

1. An actuator, including an electric motor having a stator and a rotor, in which said rotor defines a bearing surface having a non-circular profile, and a radially flexible annular sleeve defines a facing bearing surface the arrangement between the facing bearing surfaces being such that said flexible sleeve adopts a non-circular shape complementary to said profile of said bearing surface of said rotor, said flexible sleeve is restrained against rotation and is in toothed meshing engagement with a circular drive ring at least two contact regions which are equidistantly spaced apart, said drive ring is rotationally engaged with a screw and threaded sleeve assembly, such that rotation of said drive ring drives said screw and sleeve assembly and causes extension or withdrawal of an output portion of said screw and sleeve assembly for actuation, said actuator being operable such that rotation of said rotor causes said flexible sleeve to flex radially at each of said contact regions to generate a rolling wave which causes rotation of said contact regions and of said drive ring, and whereby said drive ring rotates at a reduced rotational velocity as compared to the rotational velocity of said rotor.

2. An actuator according to claim 1, wherein said rotor includes radially outer and inner surfaces and is disposed co-axially within the stator, said rotor further includes a magnetic arrangement on said radially outer surface thereof and said radially inner surface defining said bearing race having an elliptical profile.

3. An actuator according to claim 2, wherein said magnetic arrangement is accommodated by a magnet backing ring which includes a plurality of magnets mounted to said radially outer surface of said rotor.

4. An actuator according to claim 1, wherein said flexible sleeve includes a collar and said collar defines said facing bearing surface.

5. An actuator according to claim 1, wherein said toothed meshing engagement is provided by teeth or splines formed on facing surfaces of said flexible sleeve and said drive ring.

6. An actuator according to claim 1, said screw and sleeve assembly includes an input sleeve and said output portion is an output screw, and wherein said drive ring is arranged for rotation with said input sleeve and said input sleeve is coaxial with said drive ring and with said output screw, said input sleeve being radially inboard of said drive ring and radially outboard of said output screw.

7. An actuator according to claim 6, wherein said drive ring is in toothed meshing engagement with said input sleeve.

8. An actuator according to claim 6, wherein said input sleeve is restrained against axial movement and said output screw is restrained against rotational movement, so that rotation of said input sleeve results in axial displacement of said output screw.

9. An actuator according to claim 8, wherein said input sleeve includes opposite ends and wherein a first of said ends is toothed meshing engagement with said drive ring and a second of said ends includes a head portion, said head portion having a surface which is arranged in use to face a complementary surface formed on a locating nut, said locating nut limiting axial movement of said input sleeve by engagement of said facing surfaces.

10. An actuator according to claim 9, wherein said facing surfaces are inclined.

11. An actuator according to claim 6, wherein in use, said output screw engages against the rear of a brake pad for displacing said brake pad into engagement with a disc of a disc brake caliper.

12. An actuator according to claim 6, wherein in use, said output screw engages against a load spreading device which is in engagement with the rear of a brake pad, for displacing said brake pad into engagement with a disc of a disc brake caliper.

13. An actuator according to claim 1, said screw and sleeve assembly includes an input screw and said output portion is an output sleeve, and wherein said drive ring is connected for rotation with said input screw and said input screw is coaxial with said drive ring and with said output sleeve, said input screw is restrained against axial movement and said input sleeve is restrained against rotational movement, so that rotation of said input screw results in axial displacement of said output sleeve.

14. An actuator according to claim 1, said screw and sleeve assembly being a ball screw assembly.

15. An actuator according to claim 1, wherein said bearing surface of said rotor defines a ball bearing race and said bearing surface of said flexible sleeve defines a facing ball bearing race, and balls are disposed between and in rolling contact with said respective ball bearing races.

16. An actuator according to claim 1, said bearing surface of said rotor has an elliptical profile, such that said flexible sleeve adopts an elliptical shape complementary to said elliptical profile, and wherein said flexible sleeve is in toothed meshing engagement with said drive ring at two contact regions which are diametrically opposed such that said rolling wave is elliptical.

17. An actuator according to claim 1, said bearing surface of said rotor has a profile such that said flexible sleeve is in toothed meshing engagement with said drive ring at three equidistantly spaced contact regions.

18. An actuator according to claim 1, wherein said flexible sleeve includes a head portion end which is anchored to restrain said sleeve against rotational movement.

19. An actuator according to claim 18, said head portion being formed remote from said toothed meshing engagement between said flexible sleeve and said drive ring.

20. An actuator according to claim 18, said head portion depending from said flexible sleeve radially outwardly.

21. An actuator according to claim 18, said head portion being substantially annular.

22. An actuator according to claim 18, wherein said head portion is anchored in use between a housing portion of a disc brake caliper and a threaded nut that threadably engages said housing portion.

23. (canceled)

24. An actuator according to claim 1, said screw and sleeve assembly includes a sleeve which extends about a screw and said sleeve and said screw are coaxial and rotatable relative to each other, wherein interposed between said sleeve and said screw for a portion of the coaxial extent thereof, is a plurality of balls, said sleeve closely overlies said screw for the remaining portion of the coaxial extent and said sleeve extends beyond the axial extent of said screw to define a radially inwardly facing journal surface for sliding engagement with a support which is fixed to and extends from said screw, for supporting said screw relative to said sleeve to restrain movement from coaxial with said sleeve.

25. An actuator according to claim 1, wherein said toothed meshing engagement is arranged such that the number of teeth of said flexible sleeve is greater than the number of teeth of said drive ring by an amount divisible by the number of said contact regions.

26. An actuator according to claim 1, said actuator being a brake assembly actuator.

27. A disc brake caliper including an actuator according to claim 1.

28. A disc brake caliper including a housing arranged to straddle a rotor disc and an anchor bracket for attaching the caliper to a vehicle, the housing supporting a pair of brake pads on opposite sides of the disc and displacement of a first of the brake pads into engagement with one side of the disc causes said housing to shift relative to said anchor bracket to bring the second of said brake pads into engagement with a second and opposite side of the disc, said housing at least partly accommodating an actuator for displacing said first brake pad into engagement with said disc, said actuator including an electric motor having a stator and a rotor, in which said rotor defines a bearing surface having a non-circular profile, and a radially flexible annular sleeve defines a facing bearing surface the arrangement between the facing bearing surfaces being such that said flexible sleeve adopts a non-circular shape complementary to said profile of said bearing surface of said rotor, said flexible sleeve is restrained against rotation and is in toothed meshing engagement with a circular drive ring at least two contact regions which are equidistantly spaced apart, said drive ring is rotationally engaged with a screw and threaded sleeve assembly, such that rotation of said drive ring drives said screw and sleeve assembly and causes extension or withdrawal of an output portion of the said ball screw assembly for displacement of said first brake pads, said actuator being operable such that rotation of said rotor causes said flexible sleeve to flex radially at each of said contact regions to generate a rolling wave which causes rotation of said contact regions and of said drive ring, and whereby said drive ring rotates at a reduced rotational velocity as compared to the rotational velocity of said rotor.

29. A disc brake caliper according to claim 28, said stator being fixed to said housing radially outwardly of said rotor.

30. A disc brake caliper according to claim 28, said housing including a removable cover that extends about an end section of said housing, removal of said cover allowing access to said actuator.

31. An actuator according to claim 9, wherein said flexible sleeve includes a head portion end which is anchored to restrain said sleeve against rotational movement.

32. An actuator according to claim 31, wherein said head portion of said flexible sleeve is adjacent to said head portion of said input sleeve with a bearing interposed between said respective head portions to facilitate relative rotation and reaction of axial loading of said input sleeve to said head portion of said flexible sleeve.
